(19) United States
(12) Patent Application Publication
(10) Pub. No.: US 2025/0016654 A1
(43) Pub. Date: Jan. 9, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Xingyue ZHOU, Shenzhen (CN); Jinguo ZHU, Shenzhen (CN); Hao DONG, Shenzhen (CN)

(21) Appl. No.: 18/706,246

(22) PCT Filed: Nov. 1, 2021
(86) PCT No.: PCT/CN2021/127946

§ 371 Date: Apr. 30, 2024

(51) Int. Cl. H04W 40/22; H04L 45/24

(52) U.S. Cl. CPC H04W 40/22; H04L 45/24

(57) ABSTRACT

Method, device and computer program product for wireless communication are provided. A method includes: receiving, by an access and mobility management node from a radio access node, a first request message with relay information; and transmitting, by the access and mobility management node to a session management node, a second request message with the relay information to allow the session management node to activate one or more Protocol Data Unit, PDU, sessions over a relay path.

This document is directed generally to wireless communications, in particular to 5^{th} generation (5G) wireless communication.

Support of simultaneous direct network communication path and indirect communication path can improve the communication reliability. There is ongoing study on how to support multiple paths for a UE (user equipment) in ProSe (Proximity-based Services) scenario. However, it is needed to figure out how to establish and manage the connections to the network when simultaneously having direct network communication path and indirect communication path.

The present disclosure relates to methods, devices, and computer program products for wireless communication corresponding to a relay path.

One aspect of the present disclosure relates to a wireless communication method. In an embodiment, the wireless communication method includes: receiving, by an access and mobility management node from a radio access node, a first request message with relay information; and transmitting, by the access and mobility management node to a session management node, a second request message with the relay information to allow the session management node to activate one or more Protocol Data Unit, PDU, sessions over a relay path.

Another aspect of the present disclosure relates to a wireless communication method. In an embodiment, the wireless communication method includes: receiving, by a session management node from an access and mobility management node, a second request message with relay information; and activating, by the session management node, one or more Protocol Data Unit, PDU, sessions over a relay path according to the relay information.

Another aspect of the present disclosure relates to a wireless communication method. In an embodiment, the wireless communication method includes: transmitting, by a radio access node to an access and mobility management node, a first request message with relay information, wherein the first request message is used to allow a session management node to activate one or more Protocol Data Unit, PDU, sessions over a relay path.

Another aspect of the present disclosure relates to a wireless communication method. In an embodiment, the wireless communication method includes: transmitting, by a wireless communication terminal to a radio access node, a first request message via a relay path, wherein the first request message is transmitted to a session management node with relay information of the relay path to allow the session management node to activate one or more Protocol Data Unit, PDU, sessions over the relay path.

Another aspect of the present disclosure relates to a wireless communication method. In an embodiment, the wireless communication method includes: transmitting, by a relay node to a radio access node, a first request message from a wireless communication terminal, wherein the first request message is transmitted to a session management node with relay information of a relay path to allow the session management node to activate one or more Protocol Data Unit, PDU, sessions over the relay path.

Another aspect of the present disclosure relates to a wireless communication method. In an embodiment, the wireless communication method includes: receiving, by a relay node, address information of a MultiPath Transmission Control Protocol, MPTCP, proxy; and transmitting, by the relay node to a wireless communication terminal, the address information of the MPTCP proxy to allow the wireless communication terminal to access an MPTCP service from the MPTCP proxy via the relay node.

Another aspect of the present disclosure relates to a wireless communication method. In an embodiment, the wireless communication method includes: receiving, by a wireless communication terminal from a relay node, address information of a MultiPath Transmission Control Protocol, MPTCP, proxy; and accessing, by the wireless communication terminal, an MPTCP service from the MPTCP proxy via the relay node according to the address information of the MPTCP proxy.

Another aspect of the present disclosure relates to a wireless communication node. In an embodiment, the wireless communication node includes a communication unit and a processor. The processor is configured to: receive, from a radio access node, a first request message with relay information; and transmit, to a session management node, a second request message with the relay information to allow the session management node to activate one or more Protocol Data Unit, PDU, sessions over a relay path.

Another aspect of the present disclosure relates to a wireless communication node. In an embodiment, the wireless communication node includes a communication unit and a processor. The processor is configured to: receive, from an access and mobility management node, a second request message with relay information; and activating, one or more Protocol Data Unit, PDU, sessions over a relay path according to the relay information.

Another aspect of the present disclosure relates to a wireless communication node. In an embodiment, the wireless communication node includes a communication unit and a processor. The processor is configured to: transmit, to an access and mobility management node, a first request message with relay information, wherein the first request message is used to allow a session management node to activate one or more Protocol Data Unit, PDU, sessions over a relay path.

Another aspect of the present disclosure relates to a wireless communication node. In an embodiment, the wireless communication node includes a communication unit and a processor. The processor is configured to: transmit, to a radio access node, a first request message via a relay path, wherein the first request message is transmitted to a session management node with relay information of the relay path to allow the session management node to activate one or more Protocol Data Unit, PDU, sessions over the relay path.

Another aspect of the present disclosure relates to a wireless communication node. In an embodiment, the wireless communication node includes a communication unit and a processor. The processor is configured to: transmit, to a radio access node, a first request message from another wireless communication terminal, wherein the first request message is transmitted to a session management node with relay information of a relay path to allow the session management node to activate one or more Protocol Data Unit, PDU, sessions over the relay path.

Another aspect of the present disclosure relates to a wireless communication node. In an embodiment, the wireless communication node includes a communication unit and a processor. The processor is configured to: receive address information of a MultiPath Transmission Control Protocol, MPTCP, proxy; and transmit, to another wireless communication terminal, the address information of the MPTCP proxy to allow the another wireless communication terminal to access an MPTCP service from the MPTCP proxy via the relay node.

Another aspect of the present disclosure relates to a wireless communication node. In an embodiment, the wireless communication node includes a communication unit and a processor. The processor is configured to: receive, from a relay node, address information of a MultiPath Transmission Control Protocol, MPTCP, proxy; and access an MPTCP service from the MPTCP proxy via the relay node according to the address information of the MPTCP proxy.

Various embodiments may preferably implement the following features:

Preferably, the relay information comprises a radio access technology, RAT, type for the relay path.

Preferably, the relay information comprising an indication of a User Equipment-to-Network relay or an indication of a PC5 interface.

Preferably, the indication of a PC5 interface indicates a path via a PC5 interface and a Uu interface.

Preferably, the first request message indicates a capability of a wireless communication terminal for a multi-access, MA, PDU session over two or more radio access paths.

Preferably, the access and mobility management node is configured to transmit an indication to the session management node that a requested MA PDU session is associated with the relay path.

Preferably, the access and mobility management node is configured to transmit the second request message with the relay information to the session management node, to allow the session management node to establish an MA PDU session over the relay path and an existing path without releasing a configuration of the existing path.

Preferably, the session management node is configured to receive an indication from the access and mobility management node that a requested MA PDU session is associated with the relay path.

Preferably, the session management node is configured to establish an MA PDU session over the relay path and an existing path without releasing a configuration of the existing path in response to the second request message.

Preferably, the first request message is used to allow the session management node to establish an MA PDU session over the relay path and an existing path without releasing a configuration of the existing path.

Preferably, the address information of the MPTCP proxy comprises at least one of:
an Internet Protocol, IP, address;
a prefix;
a port number;
a Fully Qualified Domain Name, FQDN; or
a Data Network Access Identifier, DNAI.

Preferably, the relay node is configured to receive the address information of the MPTCP proxy during a registration procedure to the core network.

Preferably, the address information of the MPTCP proxy is transmitted to the wireless communication terminal in a discovery procedure performed by the wireless communication terminal.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

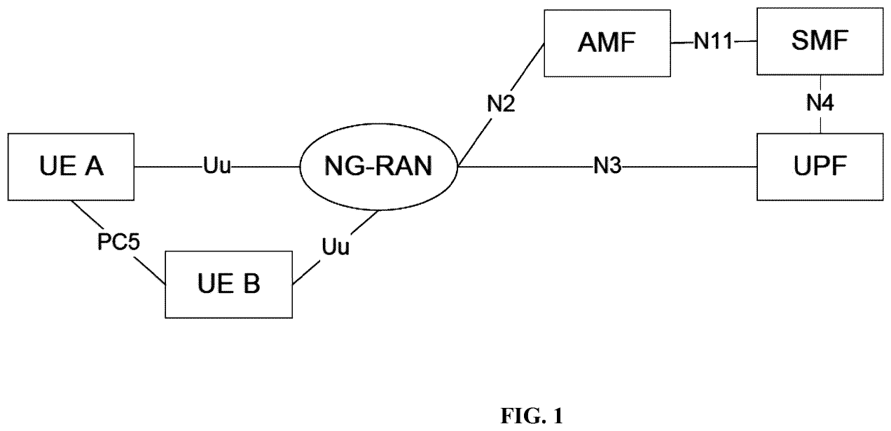

FIG. 1 shows a schematic diagram of a network with multiply paths from UE to the core network according to an embodiment of the present disclosure.

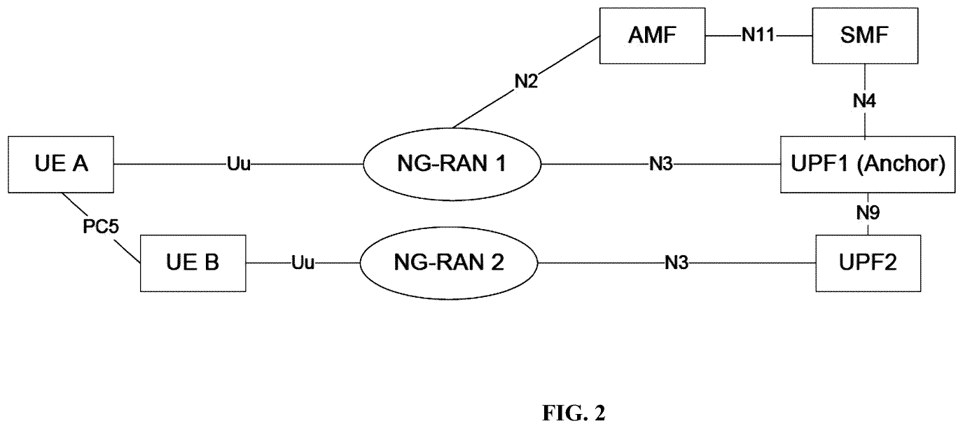

FIG. 2 shows a schematic diagram of another network with multiply paths from UE to the core network according to an embodiment of the present disclosure.

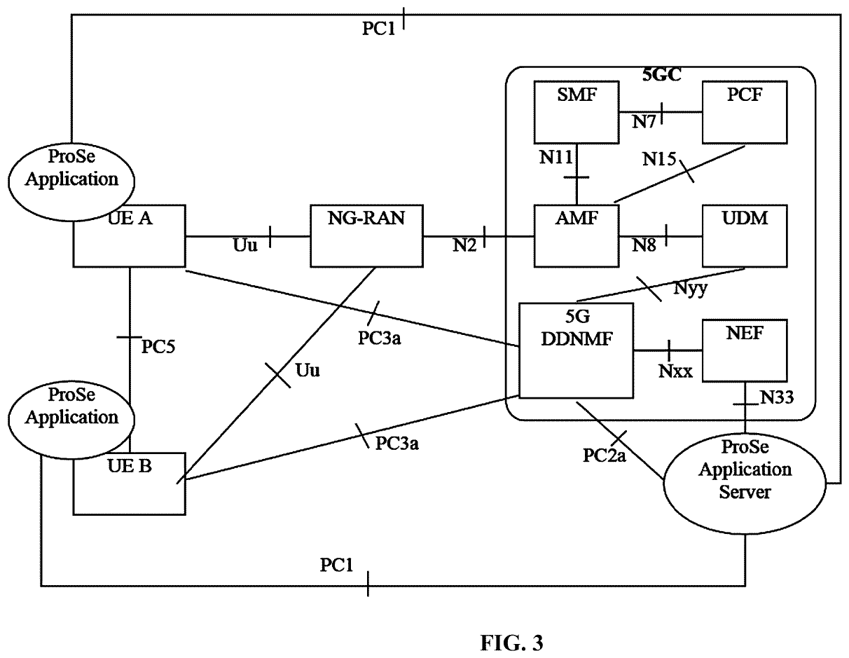

FIG. 3 shows architecture for Proximity-based Services according to an embodiment of the present disclosure.

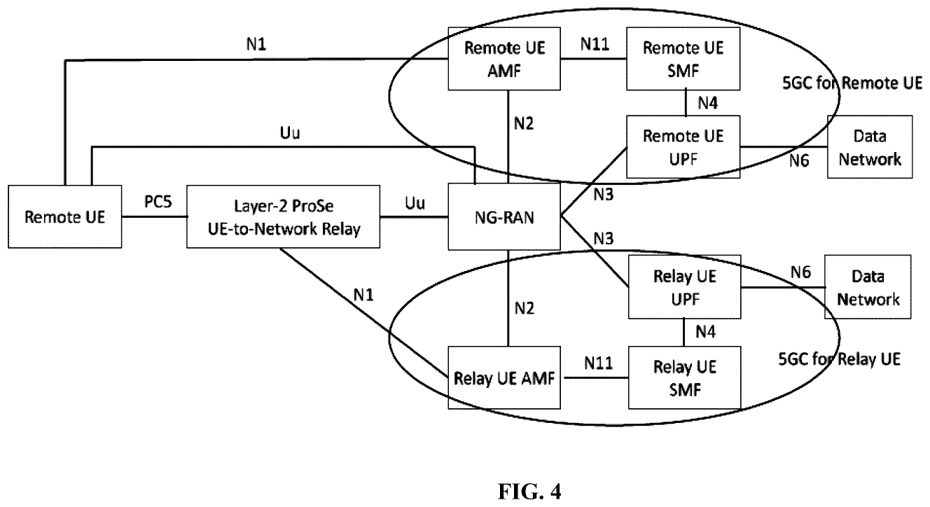

FIG. 4 shows architecture for using a 5G ProSe Layer-2 UE-to Network Relay according to an embodiment of the present disclosure.

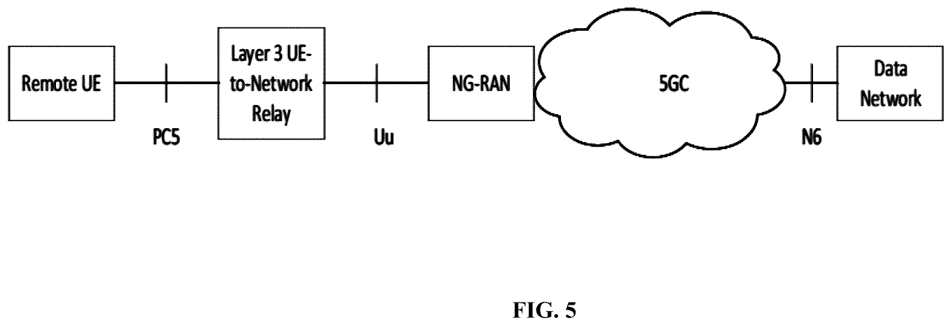

FIG. 5 shows architecture for using a 5G ProSe Layer-L UE-to Network Relay according to an embodiment of the present disclosure.

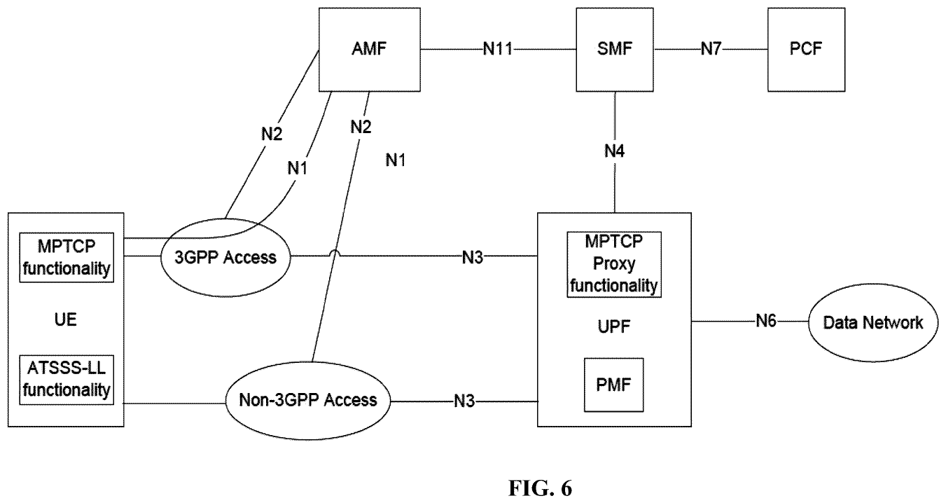

FIG. 6 shows a schematic diagram 5GS (5G system) architecture according to an embodiment of the present disclosure.

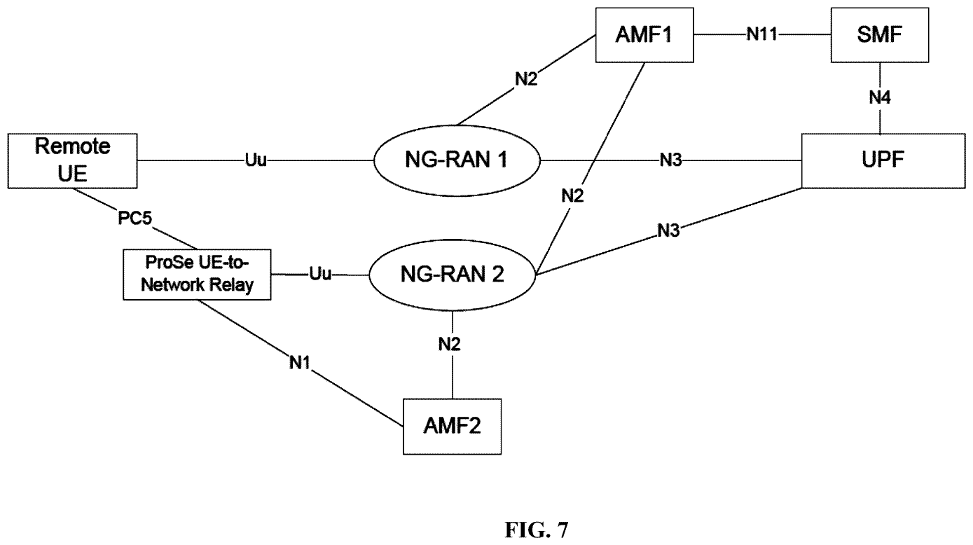

FIG. 7 shows architecture for using a 5G ProSe Layer-2 UE-to Network Relay according to an embodiment of the present disclosure.

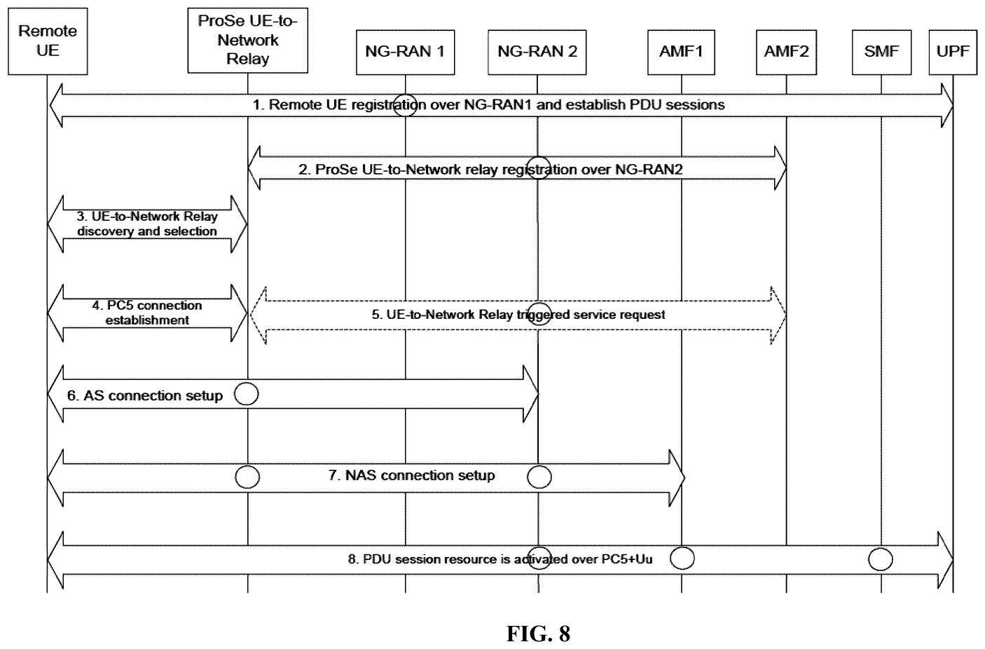

FIG. 8 shows a schematic diagram of a procedure of handover of a PDU session from NG-RAN1 to ProSe Layer-2 UE-to-Network Relay according to an embodiment of the present disclosure.

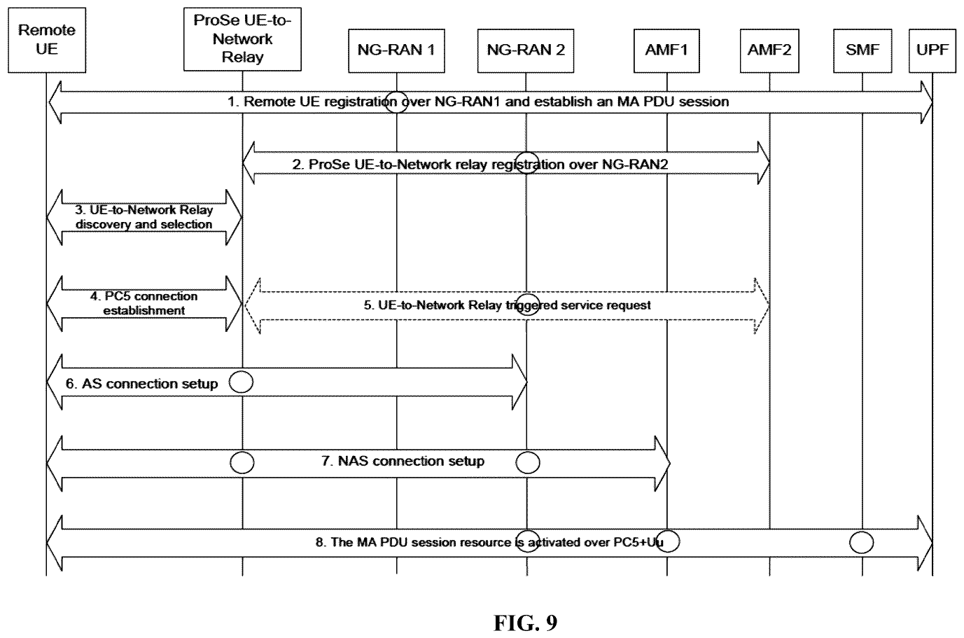

FIG. 9 shows a schematic diagram of a procedure of establishing an MA PDU session via the NG-RAN 1 and via the relay path including the ProSe UE-to-Network Relay and the NG-RAN 2 in accordance with an embodiment of the present disclosure.

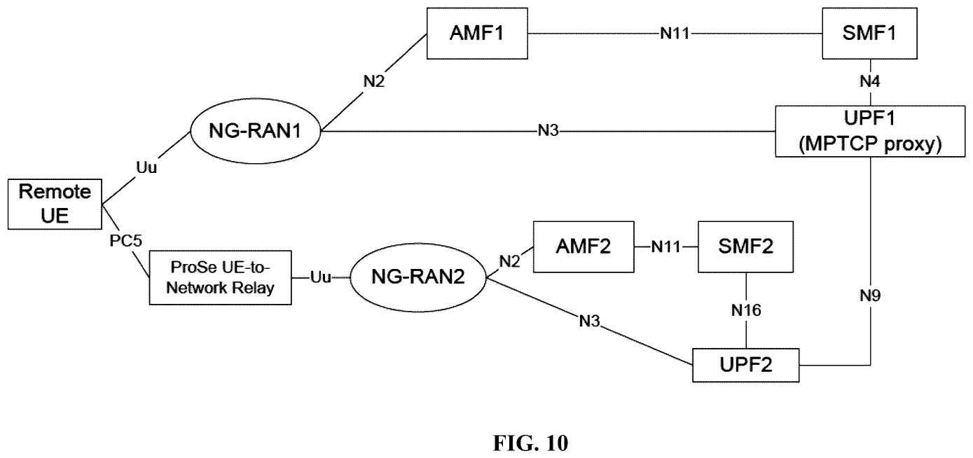

FIG. 10 shows architecture for using a 5G ProSe Layer-3 UE-to Network Relay according to an embodiment of the present disclosure.

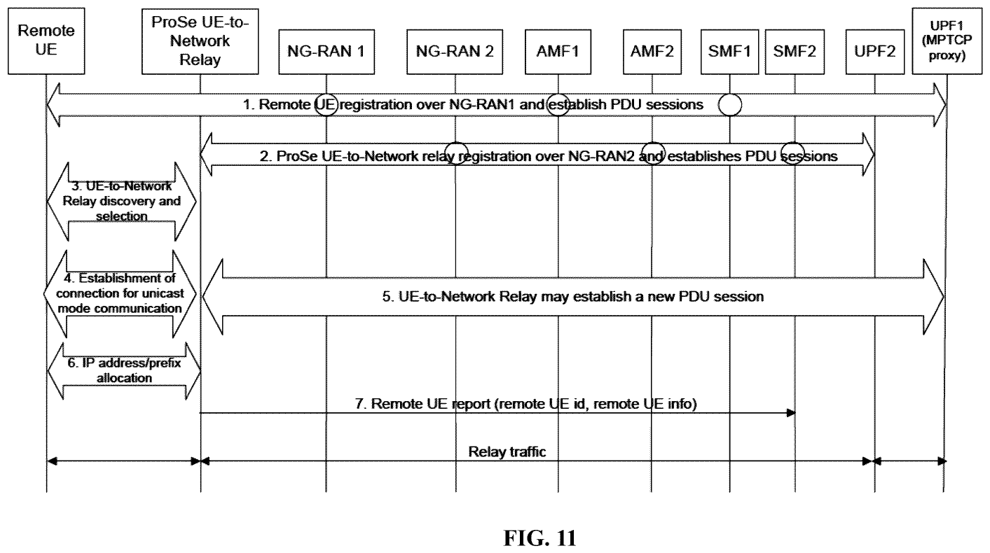

FIG. 11 shows a schematic diagram of a procedure for accessing an MPTCP proxy service according to an embodiment of the present disclosure.

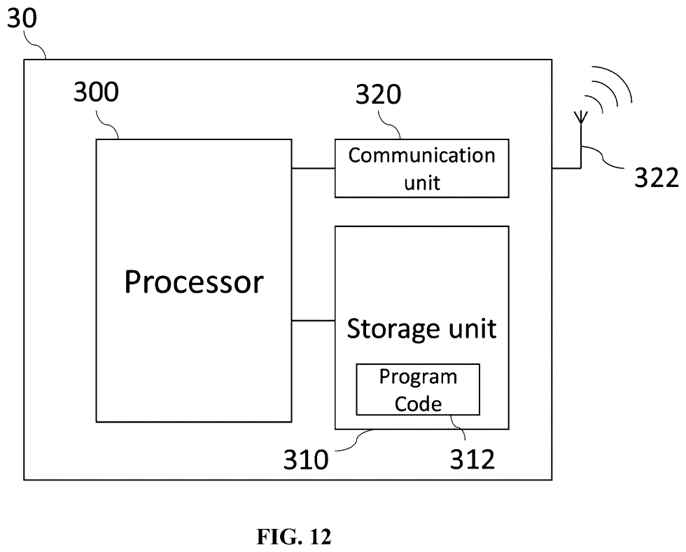

FIG. 12 shows a schematic diagram of a wireless communication node according to an embodiment of the present disclosure.

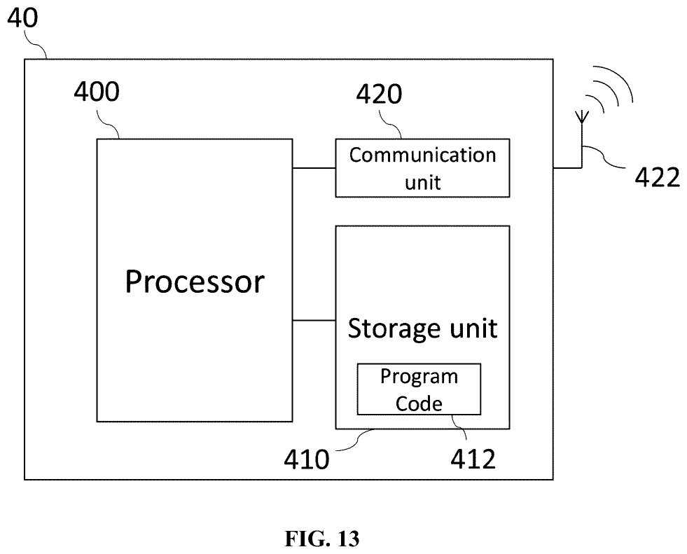

FIG. 13 shows a schematic diagram of a wireless communication terminal according to an embodiment of the present disclosure.

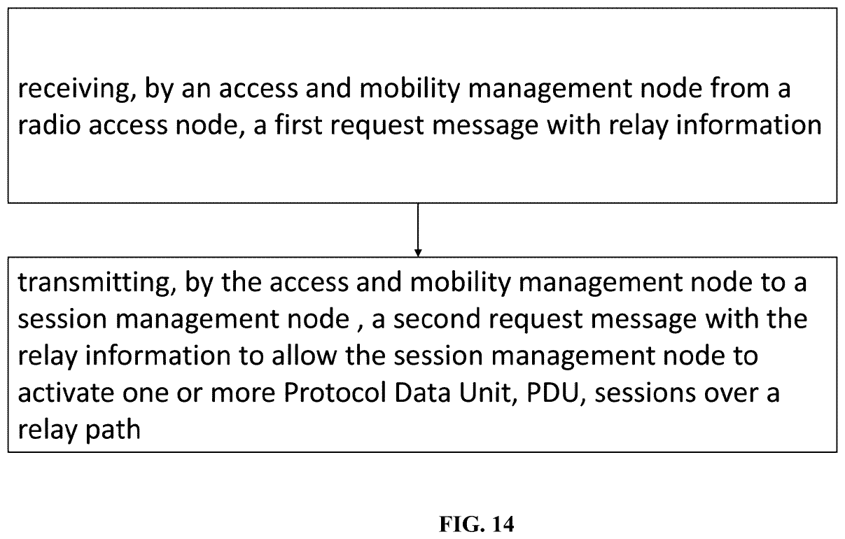

FIG. 14 shows a flowchart of a wireless communication method according to an embodiment of the present disclosure.

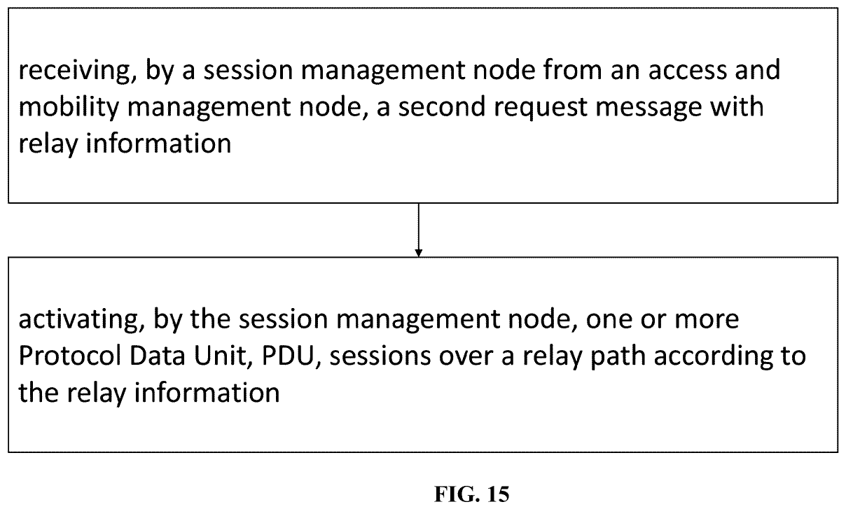

FIG. 15 shows a flowchart of another wireless communication method according to an embodiment of the present disclosure.

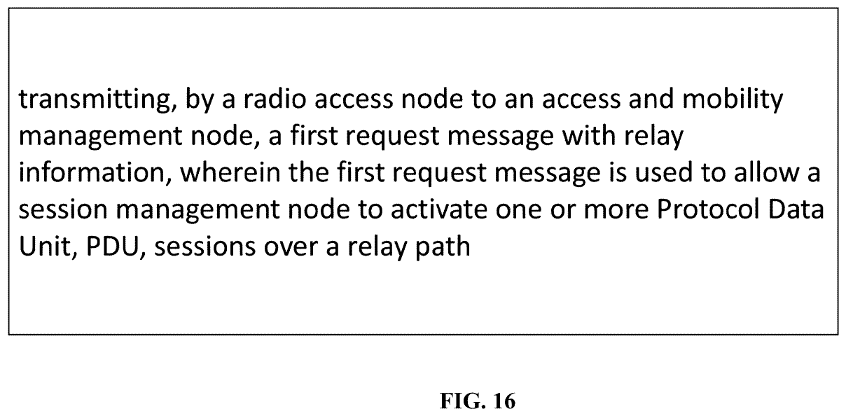

FIG. 16 shows a flowchart of another wireless communication method according to an embodiment of the present disclosure.

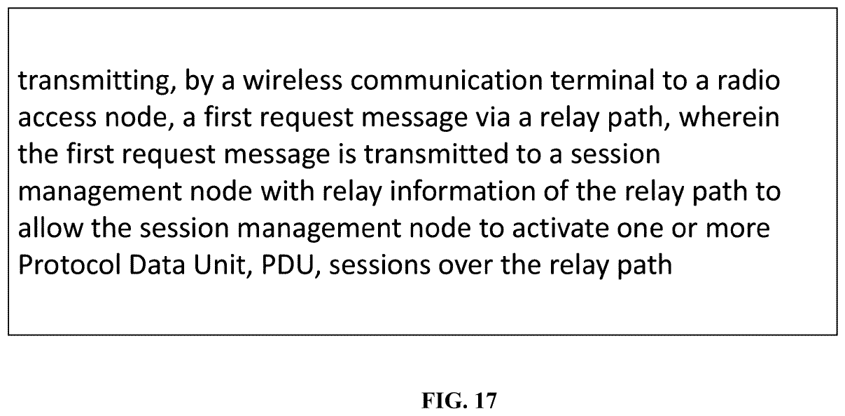

FIG. 17 shows a flowchart of another wireless communication method according to an embodiment of the present disclosure.

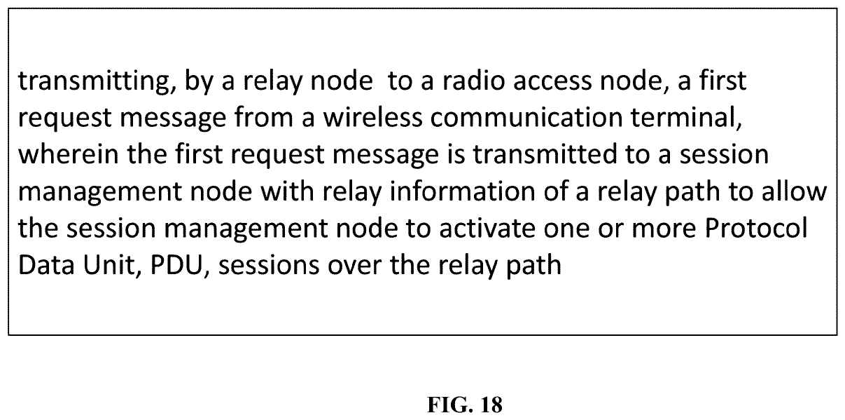

FIG. 18 shows a flowchart of another wireless communication method according to an embodiment of the present disclosure.

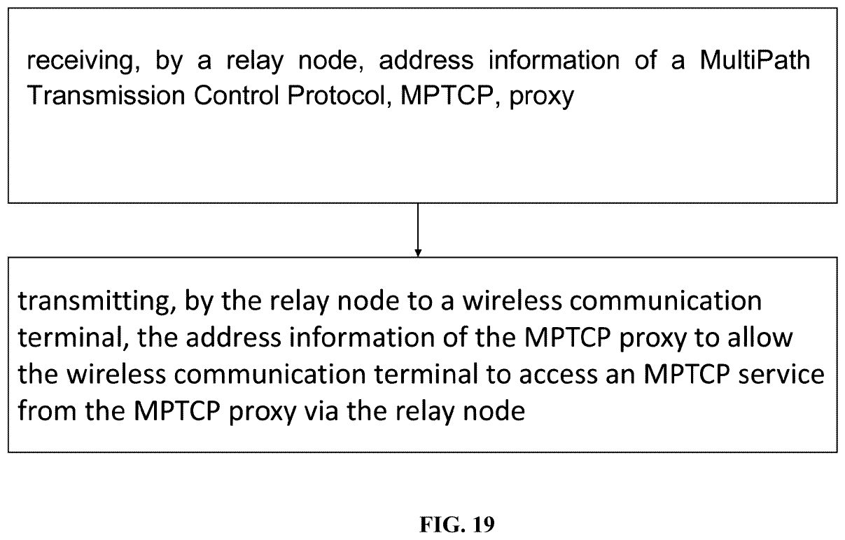

FIG. 19 shows a flowchart of another wireless communication method according to an embodiment of the present disclosure.

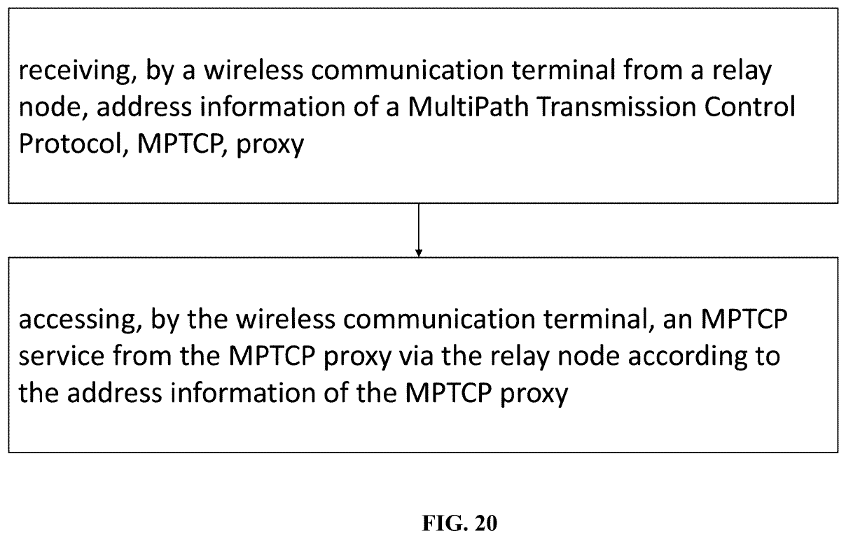

FIG. 20 shows a flowchart of another wireless communication method according to an embodiment of the present disclosure.

In some embodiments, multiple paths may be used for a UE in ProSe scenario. FIGS. 1 and 2 shows two cases for a UE simultaneously having a direct network communication path and an indirect communication path for improved reliability.

Proximity Services are services that can be provided by the 3GPP (3rd Generation Partnership Project) system based on UEs being in proximity to each other.

FIG. 3 shows a high-level view of the non-roaming 5G System architecture for ProSe.

FIG. 4 shows 5G ProSe Layer-2 UE-to-Network Relay architecture. The 5G ProSe Layer-2 Remote UE and 5G ProSe Layer-2 UE-to-Network Relay may be served by the same or different PLMNs (public land mobile networks).

The Uu interface between the 5G ProSe Layer-2 Remote UE and NG-RAN (Next-Generation Radio Access Network) applies RRC (Radio Resource Control) protocol, SDAP (Service Data Adaption Protocol) and PDCP (Packet Data Convergence Protocol).

The 5G ProSe Layer-2 Remote UE and 5G ProSe Layer-2 UE-to-Network Relay are served by the same NG-RAN. The Core Network entities (e.g., AMF (Access and Mobility Management Function), SMF (Session Management Function), and UPF (User Plane Function)) serving the 5G ProSe Layer-2 Remote UE and the 5G ProSe Layer-2 UE-to-Network Relay can be the same or different.

FIG. 5 shows high level reference architecture for 5G ProSe Layer-3 UE-to-Network Relay. In this figure, the 5G ProSe Layer-3 UE-to-Network Relay may be in the HPLMN (Home Public Land Mobile Network) or a VPLMN (Visited Public Land Mobile Network).

ATSSS (Access Traffic Steering, Switching and Splitting) can be supported by the UE and the 5GC network (5G core network) enabling a multi-access PDU (Protocol Data Unit) connectivity service, which can exchange PDUs between the UE and a data network by simultaneously using one 3GPP access network and one non-3GPP access network and two independent N3/N9 tunnels between the PSA (PDU session anchor) and RAN (radio access network) or AN (access network). The multi-access PDU connectivity service is realized by establishing a multi-access PDU (MA PDU) session, and that is, a PDU session that may have user-plane resources on two access networks.

In some embodiments, the UE may request an MA PDU session when the UE is registered via both 3GPP and non-3GPP accesses, or when the UE is registered via one access only.

After the establishment of an MA PDU session, and when there are user-plane resources on both access networks, the UE applies a network-provided policy (i.e., ATSSS rules) and decides the distribution of the uplink traffic across the two access networks according to local conditions (such as network interface availability, signal loss conditions, user preferences, etc.). Similarly, the UPF anchor of the MA PDU session applies network-provided policy (i.e., N4 rules) and feedback information received from the UE via the user-plane (such as access network unavailability or availability) for deciding the distribution of the downlink traffic across two N3/N9 tunnels and two access networks. When there are user-plane resources on only one access network, the UE applies the ATSSS rules and considers local conditions for triggering the establishment or activation of the user plane resources over another access. The type of a MA PDU Session may be one of the following types: IPv4 (Internet Protocol version 4), IPv6 (Internet Protocol version 6), IPv4/IPv6 (dual stack), and Ethernet.

FIG. 6 shows architecture with ATSSS support in 5G System according to an embodiment.

In some embodiments, the UE supports one or more of the steering functionalities, e.g., MPTCP (MultiPath Transmission Control Protocol) functionality and/or ATSSS-LL (ATSSS Lower Layer) functionality. Each steering functionality supported by the UE enables traffic steering, switching and splitting across 3GPP access and non-3GPP access, in accordance with the ATSSS rules provided by the network. In some embodiments, the ATSSS-LL functionality is mandatory for the UE for a MA PDU session.

In some embodiments, the UPF may support MPTCP Proxy functionality, which communicates with the MPTCP functionality of the UE by using the MPTCP protocol.

In some embodiments, the UPF may support ATSSS-LL functionality, which is similar to the ATSSS-LL functionality of the UE. There is no user plane protocol defined between the ATSSS-LL functionality in the UE and the ATSSS-LL functionality in the UPF. The ATSSS-LL functionality in the UPF is not shown in FIG. 6.

In some embodiments, the UPF supports Performance Measurement Functionality (PMF), which may be used by the UE to obtain access performance measurements over the user-plane of 3GPP access and/or over the user-plane of non-3GPP access.

### EMBODIMENT 1

FIG. 7 shows a schematic diagram of a network according to an embodiment of the present disclosure. FIG. 8 shows a schematic diagram of a procedure of handover of a PDU session from NG-RAN1 to ProSe Layer-2 UE-to-Network Relay (from direct network communication path to indirect communication path) according to an embodiment of the present disclosure.

In this embodiment, the remote UE is in the coverage of the NG-RAN 1. The remote UE discovers the ProSe Layer-2 UE-to-Network Relay and selects the Layer-2 UE-to-Network Relay to establish the PC5 connection. In this case, the remote UE is able to switch the PDU session from the NG-RAN 1 to the ProSe Layer-2 UE-to-Network Relay.

Step 1: In the coverage of NG-RAN 1, the remote UE performs the initial registration to the core network. The AMF1 is the serving AMF to the remote UE. The remote UE establishes one or more PDU sessions over NG-RAN1.

Step 2: In the coverage of NG-RAN 2, the ProSe Layer-2 UE-to-Network Relay performs the initial registration to the core network. The serving AMF can be AMF1 or another AMF (i.e., AMF2).

Step 3: The remote UE and ProSe Layer-2 UE-to-Network Relay perform ProSe UE-to-Network Relay Discovery and selection procedure.

Step 4: The remote UE initiates a one-to-one communication connection with the selected ProSe Layer-2 UE-to-Network Relay over the PC5 interface. That is, the remote UE and ProSe Layer-2 UE-to-Network Relay establish a PC5 connection.

Step 5: If the ProSe Layer-2 UE-to-Network Relay is in a CM_IDLE state, triggered by the request received from the ProSe Layer-2 Remote UE, the ProSe Layer-2 UE-to-Network Relay performs a Service Request procedure.

Step 6: The remote UE establishes an RRC connection with the same NG-RAN (i.e., NG-RAN2) serving the selected ProSe Layer-2 UE-to-Network Relay.

Step 7: The remote UE establishes an NAS (Non-access stratum) connection with AMF1. In an embodiment, the remote UE sends an NAS message to the AMF1.

In an embodiment, the NAS message from the remote UE is encapsulated in a Uu RRC message that is sent over the PC5 interface to the ProSe Layer-2 UE-to-Network Relay. The ProSe Layer-2 UE-to-Network Relay forwards the Uu RRC message to the NG-RAN2.

In an embodiment, the NG-RAN2 selects the remote UE's serving AMF (i.e., AMF1) and transmits the NAS message to this AMF. In an embodiment, the NG-RAN2 transmits the NAS message with relay information to the AMF1.

In an embodiment, the relay information includes the RAT type via which the NAS message is delivered (e.g., the relay path). In an embodiment, the AMF1 learns from the N2 interface the RAT type via which the NAS message is delivered. In one embodiment, the AMF1 receives an N2 message including the NAS message and the relay information.

In an embodiment, the relay information may include an indication of a UE-to-Network Relay or an indication of the PC5 interface. In an embodiment, the indication of the PC5 interface indicates a path via the PC5 interface and the Uu interface. For example, the RAT type may be one of the following: (1) ProSe UE-to-Network Relay+Uu; (2) ProSe UE-to-Network Relay+NG-RAN; or (3) PC5+Uu. Note that the RAT type may be represented as another expression, and the present disclosure is not limited to the embodiment described above.

The NAS message contains the PDU session ID(s) of which the PDU session(s) are expected to be transferred from NG-RAN1 to the relay path (from the direct network communication path to the indirect communication path).

Step 8: The AMF1 sends an Nsmf_PDUSession_UpdateSMContext Request with the relay information to the SMF, to allow the SMF activate the PDU session(s) (e.g., activate the PDU session resource) over the relay path (e.g., over the ProSe Layer-2 UE-to-Network Relay).

### EMBODIMENT 2

FIG. 9 shows a schematic diagram of a procedure of establishing an MA PDU session via the NG-RAN 1 and via the relay path including the ProSe UE-to-Network Relay and the NG-RAN 2 in accordance with an embodiment of the present disclosure.

In this embodiment, the remote UE is in the coverage of the NG-RAN 1. The remote UE discovers the ProSe Layer-2 UE-to-Network Relay and selects the Layer-2 UE-to-Network Relay to establish the PC5 connection. In this case, the remote UE can use these two paths for steering, switching or splitting the traffic by establishing an MA PDU session (see FIG. 7).

Step 1: In the coverage of NG-RAN 1, the remote UE performs the initial registration to the core network. The remote UE establishes an MA PDU session via the NG-RAN1. In an embodiment, one access leg of an MA PDU session is over the NG-RAN1.

Steps 2 to 6 in this embodiment are similar or identical to Steps 2 to 6 in Embodiment 1, and are not repeated herein.

Step 7: The remote UE establishes an NAS connection with AMF1. In an embodiment, the remote UE sends an NAS message to the AMF1. In an embodiment, the NAS message is an NAS (Non-access stratum) message. In an embodiment, the NAS message is used to activate one or more PDU sessions.

In an embodiment, the NAS message is encapsulated in a Uu RRC message that is sent over PC5 interface to the ProSe Layer-2 UE-to-Network Relay. The ProSe Layer-2 UE-to-Network Relay forwards the Uu RRC message to the NG-RAN2.

In an embodiment, the NG-RAN2 selects the remote UE's serving AMF (i.e., AMF1) and transmits the NAS message to this AMF. In an embodiment, the NG-RAN2 transmits the NAS message with relay information to the AMF1.

In an embodiment, the relay information includes the RAT type via which the NAS message is delivered (e.g., the relay path). In an embodiment, the AMF1 learns from the N2 interface the RAT type via which the NAS message is delivered.

In an embodiment, the relay information may include an indication of a UE-to-Network Relay or an indication of PC5 interface. For example, the RAT type may be one of the following: (1) ProSe UE-to-Network Relay+Uu; (2) ProSe UE-to-Network Relay+NG-RAN; or (3) PC5+Uu. Note that the RAT type may be represented as another expression, and the present disclosure is not limited to the embodiment described above.

In an embodiment, the NAS message contains the PDU session ID(s) of which the PDU session(s) are expected to be activated.

In an embodiment, the NAS message indicates the capability of the remote UE for supporting MA PDU sessions over two or more radio access paths (e.g., 3GPP access). In an embodiment, the remote UE indicates its capability of establishing an MA PDU session over 3GPP access and 3GPP access, or more than two 3GPP accesses in the NAS message.

In an embodiment, the relay path via the ProSe UE-to-Network Relay can be regarded as a 3GPP access. That is, the RAT type like ProSe UE-to-Network Relay+Uu, or ProSe UE-to-Network Relay+NG-RAN, or PC5+Uu can be regarded as a 3GPP access.

Step 8: The AMF1 sends an Nsmf_PDUSession_UpdateSMContext Request with the relay information to the SMF, to allow the SMF activate or re-activate the MA PDU session (e.g., activate the MA PDU session resource) over the relay path (e.g., over the ProSe Layer-2 UE-to-Network Relay).

In an embodiment, the AMF1 sends the remote UE capability mentioned in Step 7 to the SMF. The AMF1 also transmits an indication to the SMF to indicate that the MA PDU session is associated with the relay path. In an embodiment, the indication indicates that in addition to the existing 3GPP access (e.g., via the NG-RAN 1) the MA PDU session is also associated with another 3GPP access.

In an embodiment, the SMF already has the SM (session management) Contexts for the access leg of the MA PDU session over NG-RAN1, and the SMF does not release the existing SM Contexts. In an embodiment, the SMF re-activates user plane resources over the relay path for the remote UE according to the NAS message and indication from the AMF1.

### EMBODIMENT 3

FIG. 10 shows a schematic diagram of a network according to an embodiment of the present disclosure. FIG. 11 shows a schematic diagram of a procedure for accessing an MPTCP proxy service according to an embodiment of the present disclosure.

In this embodiment, the remote UE is in the coverage of the NG-RAN 1. The remote UE discovers the ProSe Layer-3 UE-to-Network Relay and selects the Layer-3 UE-to-Network Relay to establish the PC5 connection. In this case, the remote UE can obtain an IP address of the data network from the ProSe Layer-3 UE-to-Network Relay and can use the IP address to access the data network. Accordingly, the remote UE can access the data network by the PDU session established via NG-RAN1 (e.g., the first path), and ProSe Layer-3 UE-to-Network Relay (e.g., the second path) at the same time. In this embodiment, the first path is used as the first access leg of the MPTCP connection between the remote UE and the UPF1 (e.g., the MPTCP proxy in the UPF1), and the second path is used as the second leg of the MPTCP connection between the remote UE and the UPF1 (e.g., the MPTCP proxy in the UPF1).

Step 1: In coverage of the NG-RAN 1, the remote UE performs the initial registration to the network and establishes one or more PDU sessions. One of the PDU sessions is served by an UPF (i.e., UPF1) having an MPTCP proxy or an UPF (i.e., UPF1) which can access an MPTCP proxy.

Step 2: In coverage of the NG-RAN 2, the ProSe Layer-3 UE-to-Network Relay performs the initial registration to the network and may establish one or more PDU sessions.

In an embodiment, the ProSe Layer-3 UE-to-Network Relay can receive address information of the MPTCP proxy. In an embodiment, the ProSe Layer-3 UE-to-Network Relay can receive or be configured with parameters related to supporting the MPTCP service. In an embodiment, the information related to these parameters are informed to the remote UE during the discovery of a Layer-3 UE-to-Network Relay. In an embodiment, the address information and/or the parameters are received during the registration procedure to the core network.

Step 3: The remote UE performs a discovery of a Layer-3 UE-to-Network Relay. In an embodiment, the Layer-3 UE-to-Network Relay transmits the address information of the MPTCP proxy to the remote UE. In an embodiment, the address information of the MPTCP proxy indicates the ProSe Layer-3 UE-to-Network Relay supporting MPTCP service to the remote UE. In an embodiment, the address information is sent in a UE-to-Network Relay Discovery Announcement message.

In an embodiment, the remote UE learns about the MPTCP proxy service provided by the ProSe Layer-3 UE-to-Network Relay from the UE-to-Network Relay Discovery Announcement message, which includes at least one of the following addressing information of the MPTCP proxy:
IP address, prefix, and/or port number;
FQDN (Fully Qualified Domain Name); or
DNAI (Data Network Access Identifier).

Step 4: The remote UE selects the ProSe Layer-3 UE-to-Network Relay and establishes a connection for unicast mode communication according to the MPTCP proxy service information obtained in Step 3 (e.g., the address information of the MPTCP proxy).

Step 5: If there is no PDU session associated with the requested MPTCP proxy service or a new PDU Session for relaying is needed, the ProSe Layer-3 UE-to-Network Relay initiates a new PDU Session establishment procedure for relaying before completing the PC5 connection establishment.

Step 6: The ProSe Layer-3 UE-to-Network Relay allocates the IP address or prefix to the remote UE once the PDU session for the requested MPTCP proxy service is successfully established.

Step 7: The ProSe Layer-3 UE-to-Network Relay sends a Remote UE Report message, which may include a Remote User ID and/or Remote UE information, to the SMF for the PDU Session associated with the relay path.

The remote UE can access the MPTCP proxy service via the ProSe Layer-3 UE-to-Network Relay. The remote UE can establish the MPTCP sub-flows by the first path and the second path.

In accordance with an embodiment of the present disclosure, the remote UE informs its capability of establishing an MA PDU session over 3GPP access and 3GPP access, or more than two 3GPP accesses in the NAS message to the network.

In accordance with an embodiment of the present disclosure, the AMF learns from N2 interface that the RAT type which is represented as ProSe UE-to-Network Relay+Uu, or ProSe UE-to-Network Relay+NG-RAN, or PC5+Uu. The expression of this RAT type is not limited to the embodiment above.

In accordance with an embodiment of the present disclosure, the RAT type represented as ProSe UE-to-Network Relay+Uu, or ProSe UE-to-Network Relay+NG-RAN, or PC5+Uu is interpreted as 3GPP access.

In accordance with an embodiment of the present disclosure, the AMF informs the SMF the RAT Type represented as ProSe UE-to-Network Relay+Uu, ProSe UE-to-Network Relay+NG-RAN, or PC5+Uu.

In accordance with an embodiment of the present disclosure, the remote UE receives the information that the MPTCP proxy service provided by the ProSe Layer-3 UE-to-Network Relay from the Discovery Announcement message. The information refers to the MPTCP proxy addressing information including at least one of:
IP address, prefix, and/or port number;
FQDN; or
DNAI.

In accordance with an embodiment of the present disclosure, the ProSe Layer-2 UE-to-Network Relay or the ProSe Layer-3 UE-to-Network Relay may be a UE.

FIG. 12 relates to a schematic diagram of a wireless communication terminal 30 (e.g., a terminal node or a terminal device) according to an embodiment of the present disclosure. The wireless communication terminal 30 may be a user equipment (UE), a mobile phone, a ProSe Layer-2 UE-to-Network Relay, a ProSe Layer-3 UE-to-Network Relay, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE, the ProSe Layer-2 UE-to-Network Relay, and ProSe Layer-3 UE-to-Network Relay described above. In some embodiments, the processor 300 and the communication unit 320 collaboratively perform the operations described above. For example, the processor 300 performs operations and transmit or receive signals, message, and/or information through the communication unit 320.

FIG. 13 relates to a schematic diagram of a wireless communication node 40 (e.g., a network device) according to an embodiment of the present disclosure. The wireless communication node 40 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the AMF1, NG-RAN2, and the SMF described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication node (e.g., an AMF). In an embodiment, the wireless communication node may be implemented by using the wireless communication node 40 described above, but is not limited thereto.

Referring to FIG. 14, in an embodiment, the wireless communication method includes: receiving, by an access and mobility management node from a radio access node, a first request message with relay information; and transmitting, by the access and mobility management node to a session management node, a second request message with the relay information to allow the session management node to activate one or more Protocol Data Unit, PDU, sessions over a relay path.

In an embodiment, the first request message may carry the NAS message from the remote UE described above, and the second request message may be the Nsmf_PDUSession_UpdateSMContext Request described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., an SMF). In an embodiment, the wireless communication node may be implemented by using the wireless communication node 40 described above, but is not limited thereto.

Referring to FIG. 15, in an embodiment, the wireless communication method includes: receiving, by a session management node from an access and mobility management node, a second request message with relay information; and activating, by the session management node, one or more Protocol Data Unit, PDU, sessions over a relay path according to the relay information.

In an embodiment, the second request message may be the Nsmf_PDUSession_UpdateSMContext Request described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., an NG-RAN). In an embodiment, the wireless communication node may be implemented by using the wireless communication node 40 described above, but is not limited thereto.

Referring to FIG. 16, in an embodiment, the wireless communication method includes: transmitting, by a radio access node to an access and mobility management node, a first request message with relay information, wherein the first request message is used to allow a session management node to activate one or more Protocol Data Unit, PDU, sessions over a relay path.

In an embodiment, the first request message may carry the NAS message from the remote UE described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a remote UE). In an embodiment, the wireless communication terminal may be implemented by using the wireless communication terminal 30 described above, but is not limited thereto.

Referring to FIG. 17, in an embodiment, the wireless communication method includes: transmitting, by a wireless communication terminal to a radio access node, a first request message via a relay path, wherein the first request message is transmitted to a session management node with relay information of the relay path to allow the session management node to activate one or more Protocol Data Unit, PDU, sessions over the relay path.

In an embodiment, the first request message may carry the NAS message from the remote UE described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a ProSe Layer-2 UE-to-Network Relay). In an embodiment, the wireless communication terminal may be implemented by using the wireless communication terminal 30 described above, but is not limited thereto.

Referring to FIG. 18, in an embodiment, the wireless communication method includes: transmitting, by a relay node to a radio access node, a first request message from a wireless communication terminal, wherein the first request message is transmitted to a session management node with relay information of a relay path to allow the session management node to activate one or more Protocol Data Unit, PDU, sessions over the relay path.

In an embodiment, the first request message may carry the NAS message from the remote UE described above.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a ProSe Layer-3 UE-to-Network Relay). In an embodiment, the wireless communication terminal may be implemented by using the wireless communication terminal 30 described above, but is not limited thereto.

Referring to FIG. 19, in an embodiment, the wireless communication method includes: receiving, by a relay node, address information of a MultiPath Transmission Control Protocol, MPTCP, proxy; and transmitting, by the relay node to a wireless communication terminal, the address information of the MPTCP proxy to allow the wireless communication terminal to access an MPTCP service from the MPTCP proxy via the relay node. Note that the address information of the MPTCP proxy may be received from or provided by the core network or be pre-configured.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication terminal (e.g., a remote UE). In an embodiment, the wireless communication terminal may be implemented by using the wireless communication terminal 30 described above, but is not limited thereto.

Referring to FIG. 20, in an embodiment, the wireless communication method includes: receiving, by a wireless communication terminal from a relay node, address information of a MultiPath Transmission Control Protocol, MPTCP, proxy; and accessing, by the wireless communication terminal, an MPTCP service from the MPTCP proxy via the relay node according to the address information of the MPTCP proxy.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by an access and mobility management node from a radio access node, a first request message with relay information; and
transmitting, by the access and mobility management node to a session management node, a second request message with the relay information to allow the session management node to activate one or more Protocol Data Unit (PDU) sessions over a relay path; wherein the relay information comprises a radio access technology (RAT) type for the relay path, an indication of a User Equipment-to-Network relay, or an indication of a PC5 interface.

2-3. (canceled)

4. The wireless communication method of claim 1, wherein the indication of a PC5 interface indicates a path via a PC5 interface and a Uu interface.

5-32. (canceled)

33. A wireless communication method comprising:
receiving, by a relay node, address information of a MultiPath Transmission Control Protocol (MPTCP) proxy; and
transmitting, by the relay node to a wireless communication terminal, the address information of the MPTCP proxy to allow the wireless communication terminal to access an MPTCP service from the MPTCP proxy via the relay node,
wherein the address information of the MPTCP proxy comprises at least one of:
an Internet Protocol (IP) address;
a prefix;
a port number;
a Fully Qualified Domain Name (FQDN); or
a Data Network Access Identifier (DNAI).

34-35. (canceled)

36. The wireless communication method of claim 33, wherein the address information of the MPTCP proxy is transmitted to the wireless communication terminal in a discovery procedure performed by the wireless communication terminal.

37-39. (canceled)

40. A wireless communication node, comprising:
a communication unit; and
a processor configured to receive, from a radio access node, a first request message with relay information; and transmit, to a session management node, a second request message with the relay information to allow the session management node to activate one or more Protocol Data Unit (PDU) sessions over a relay path; wherein the relay information comprises a radio access technology (RAT) type for the relay path, an indication of a User Equipment-to-Network relay, or an indication of a PC5 interface.

41-49. (canceled)

50. A relay node, comprising:
a communication unit; and
a processor configured to perform the method of claim 33.

51-53. (canceled)

54. A non-transitory computer-readable medium storing codes which, when executed by a processor, cause the processor to implement a wireless communication method recited of claim 1.

55. The wireless communication node of claim 40, wherein the indication of a PC5 interface indicates a path via a PC5 interface and a Uu interface.

56. The wireless communication terminal of claim 50, wherein the address information of the MPTCP proxy is transmitted to the wireless communication terminal in a discovery procedure performed by the wireless communication terminal.

57. A non-transitory computer-readable medium storing codes which, when executed by a processor, cause the processor to implement a wireless communication method of claim 33.
